(19) United States
(12) Patent Application Publication
(10) Pub. No.: US 2020/0238912 A1
(43) Pub. Date: Jul. 30, 2020

(54) BACKUP CAMERA SYSTEM FOR A VEHICLE HAVING A TRAILER HITCH

(71) Applicant: AISIN TECHNICAL CENTER OF AMERICA, INC., Northville, MI (US)

(72) Inventors: Haruki SAKAKIBARA, Northville, MI (US); Reza YOUSEFIAN, Northville, MI (US); Huijun GUO, Northville, MI (US); Maryam MIRMOHAMMAD SADEGHI, Northville, MI (US)

(73) Assignee: AISIN TECHNICAL CENTER OF AMERICA, INC., Northville, MI (US)

(21) Appl. No.: 16/261,849

(22) Filed: Jan. 30, 2019

(51) Int. Cl. B60R 1/00; B60K 35/00; B60R 11/04; H04N 5/225; H04N 5/232

(52) U.S. Cl. CPC B60R 1/003; B60K 35/00; H04N 5/232945; H04N 5/2253; B60R 11/04

(57) ABSTRACT

A system and method for a vehicle having a trailer hitch includes at least one camera mounted to a rear of the vehicle, a display device, and processing circuitry. The processing circuitry captures a video image from the at least one camera, generates a guide line in accordance with a steering angle of the vehicle, superimposes the guide line on the video image for guiding a direction from the trailer hitch towards a coupler of a trailer, displays the captured video image with the superimposed guide line, and enlarges a view of an area centered on an end of the guideline that is adjacent to the coupler.

### BACKGROUND OF THE INVENTION

### Field of the Invention

The present disclosure relates generally to a backup camera system for a vehicle having a trailer hitch, and in particular a screen that displays a three-dimensional trailer coupler with increased positional accuracy as the vehicle approaches the trailer coupler.

### Description of the Related Art

Vehicles may be equipped with a hitch ball and a backup camera for assisting a driver to back up to a trailer coupler (where “hitch” is an operation of connecting to a trailer coupler with a hitch ball). The backup camera may assist the driver by providing a display that shows a path between the vehicle and the trailer coupler. For example, there is a system which draws a center guide line for hitching to the trailer coupler. However, it may be difficult to set the target steering angle for the driver to hitch because it may be difficult to determine whether the coupler and the hitch ball are actually aligned, because the coupler and the center guide line overlap each other such that the guide line is not clearly visible.

Also, there is a problem that the coupler of the trailer is small and it is difficult for the driver to confirm the location of the coupler on a small display.

Furthermore, it is difficult for the driver to appropriately stop the vehicle at the time of hitch operation, and it is necessary to finely adjust the longitudinal direction toward the coupler. The difficulty is that the coupler and the hitch ball overlap each other on the camera display, and it is difficult to determine the stop position of the hitch ball in the normal backward display image.

### SUMMARY OF THE INVENTION

According to embodiments of the present disclosure, there is provided a system and method for a vehicle having a trailer hitch including at least one camera mounted to a rear of the vehicle, a display device, and processing circuitry. The processing circuitry configured to capture a video image from the at least one camera, superimpose the guide line on the video image for guiding direction from the trailer hitch towards a coupler of a trailer, display the captured video image with the superimposed guide line, and enlarge a view of an area centered on an end of the guideline corresponding to the coupler.

The forgoing general description of the illustrative implementations and the following detailed description thereof are merely exemplary aspects of the teachings of this disclosure, and are not restrictive

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIGS. 1A, 1B illustrate a vehicle having a hitch ball backing towards a trailer having a trailer coupling;

FIG. 2 illustrates a backup camera system for a vehicle;

FIG. 3 illustrates a computer for the backup camera system of FIG. 2;

FIG. 4 illustrates an enlarged display of a trailer coupling;

FIG. 5 illustrates a display for a display device of the backup camera system of FIG. 2;

FIG. 6 illustrates a display for the backup camera system narrowed down to the vicinity of the center of the range assumed from the steering angle; and

FIG. 7 illustrates a display for the backup camera system where the camera captures an image from above the hitch.

### DETAILED DESCRIPTION OF THE PREFERRED EMBODIMENTS

Referring now to the drawings, wherein like reference numerals designate identical or corresponding parts throughout the several views, the following description relates to.

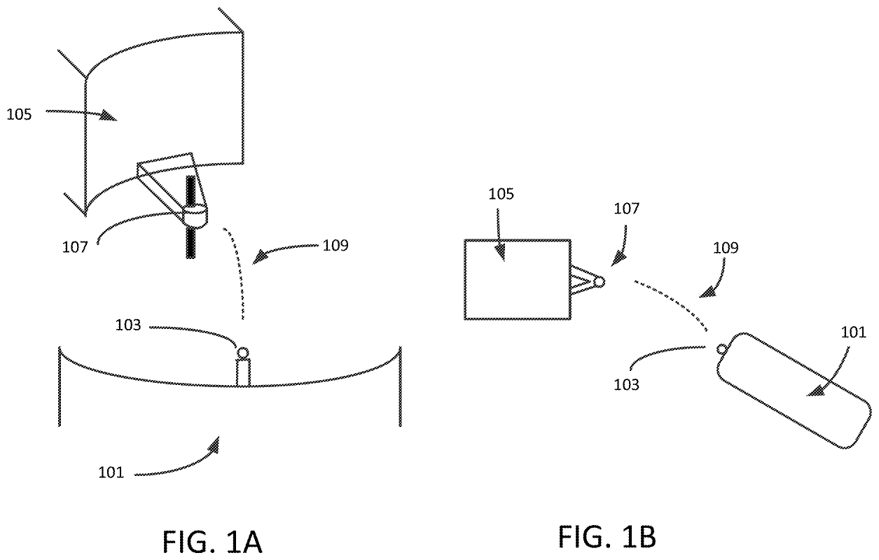

FIGS. 1A, 1B illustrate a vehicle having a hitch ball backing toward a trailer having a trailer coupling. FIG. 1A is a prospective view and FIG. 1B is a top view. A vehicle may not always be able to back up in a straight line towards a trailer in order to hitch with the trailer. Often, the vehicle will back up at an angle towards the trailer, for example, because the vehicle passes the trailer so that the driver gets a view of the trailer, then the driver steers the vehicle at an angle to approach the trailer. Subsequently, the vehicle 101 may back toward a trailer 105 at an angle. Regarding FIGS. 1A and 1B, the vehicle 101 includes a hitch ball 103 and the trailer 105 includes a coupler 107. A guide line 109 represents a path between the hitch ball 103 and the coupler 107 as the vehicle 101 backs up and approaches the trailer 105. Trailers may be of various configurations and sizes. For the sake of simplicity in explanation, the trailer coupling is triangular with an apex having a coupler 107 that can accept the hitch ball 103. The coupler 107 may be a cylindrical opening of a diameter sufficient to accept the hitch ball. The coupler 107 may also be a spherical cap shaped to correspond to the outer shape of the hitch ball 103. In general, couplers 107 are of designs to accept and lock with a hitch ball 103 that protrudes from a side of a vehicle. The vehicle may be any vehicle that has a trailer hitch mounted, typically to the rear of the vehicle. It is also possible that a trailer hitch may be mounted to a front of the vehicle. It is also possible that the trailer hitch may be adjustable in height and/or shape and size of hitch ball. Typically, the hitch ball is at a position away from the side of the vehicle to give room for hitching to a trailer coupler.

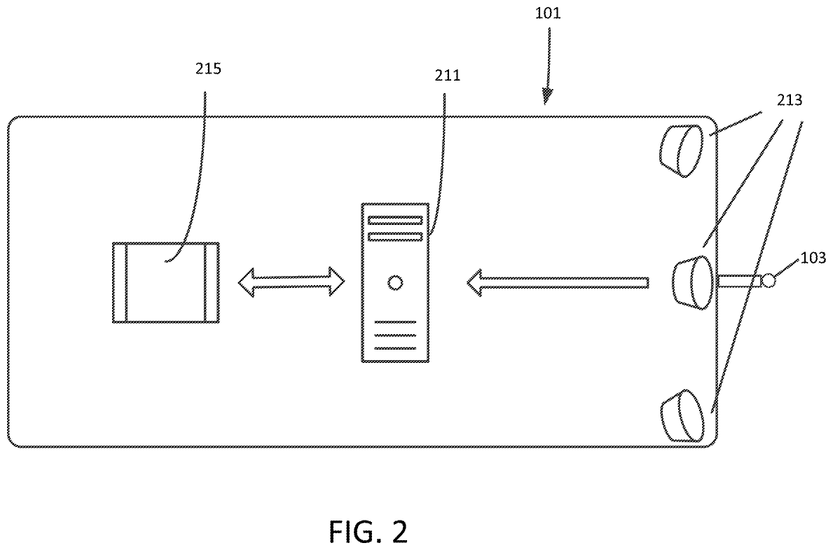

It is preferred that a vehicle having a trailer hitch also have a backup camera system to assist the driver in backing up the vehicle and hitching to the trailer coupler. FIG. 2 illustrates a backup camera system for a vehicle in accordance with an exemplary aspect of the disclosure. For purposes of clarification, only features related to this disclosure are described regarding the backup camera system. The backup camera system makes use of existing underlying functions typical of most vehicle camera backup systems. The vehicle 101 may include several cameras, such as cameras mounted to a roof of the vehicle, side view cameras, front view cameras, and rear view cameras, for purposes such as obtaining a view completely around the perimeter of the vehicle. Cameras may be used for such operations as blind spot monitoring, obstacle detection, detect the distance to another vehicle, and detect the size of the road, etc. Cameras for backup assistance may be referred to as rear backup cameras. In some aspects, a vehicle may be equipped with a single backup camera. In some aspects, a vehicle may be equipped with several backup cameras, for reasons such as size of the vehicle, and positioning of cameras needed to obtain a full view.

Regarding FIG. 2, a vehicle backup camera system may include one or more video cameras 213 and vision processing circuitry 211. The vision processing circuitry 211 receives video signals captured by the one or more video cameras 213 and outputs images to a display device 215. The display device 215 may be a multi-function display device having touchscreen capabilities. The display device 215 may be a dedicated display device for use in obtaining a rear view of the vehicle. The display device 215 may be mounted at one or more positions in the interior cabin of the vehicle, or may be a separate display device attached to the interior of the vehicle as an aftermarket device. The display device may also be a mobile device that is removable from the vehicle, and can be operated as a display device for a backup camera system while in the interior of the vehicle, or in some aspects while being carried by a user.

In the backup camera system, the one or more video cameras 213 may be arranged along the rear of the vehicle. For example, one camera may be arranged in the center of the vehicle. Other cameras may be arranged at corners of the vehicle or on a roof of the vehicle in order to extend the range of view of the backup camera system. The one or more cameras may capture images along the full width of the rear of the vehicle or may capture images at a wider view angle than the width of the vehicle, for example, to capture images of the trailer as the vehicle backs up toward the trailer from an angle, such as the angle shown in FIG. 1A. At least one of the video cameras 213 may include a wide angle lens. A video camera may include a fisheye lens to obtain a wide view from the rear of the vehicle. However, a fisheye lens may obtain a somewhat distorted view that is difficult for the driver to perceive. At least one of the cameras may include a wide angle lens that captures images over a wide vertical range from the ground to above the vehicle to obtain a view in a direction substantially toward the hitch ball 103 from above the hitch ball.

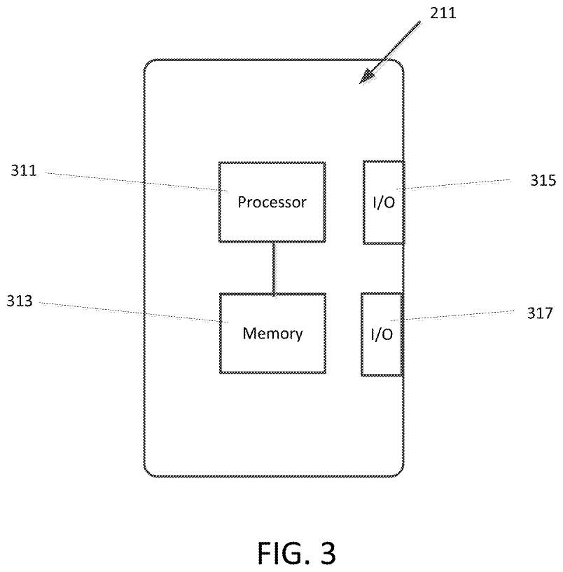

FIG. 3 illustrates vision processing circuitry for the backup camera system of FIG. 2. The vision processing circuitry 211 may be a central unit that performs control functions related to all cameras included on the vehicle, or may be a processor that handles processing for the backup camera system itself. The vision processing circuitry 211 may include a processing unit 311 and a memory 313. The vision processing circuitry 211 may include I/O interfaces 315, 317 for obtaining video signals from the one or more cameras 213 and for providing processed image signals to the display device 215. The processing unit 311 may be a microcontroller containing one or more processor cores. The memory 313 may be volatile and non-volatile. Program memory in the form of flash, ROM, EPROM, or EEPROM may be included on chip, as well as a secondary RAM for data storage. Although the description is of a microcontroller arrangement, it should be understood that other microcontroller arrangements may be used. Microcontrollers vary based on the number of processing cores, size of non-volatile memory, the size of data memory, as well as whether or not it includes an A/D converter or D/A converter. The vision processing circuitry 211 may also include a specialized processor that handles vision processing, such as a graphics processing unit (GPU) and/or a digital signal processor (DSP).

As a vehicle 101 backs up, the backup camera system may obtain video signals of the trailer coupling and superimpose a guide line 109 that is generated in accordance with the steering angle of the vehicle. The driver may view the guide line 109 on the display device 215 in order to adjust the target steering angle to hitch to the trailer coupler 107. As noted above, the guide line 109 and trailer coupler 107 may overlap in a captured image such that it is difficult to visualize the guide line. In one embodiment, when the guide line 109 approaches the trailer coupler 107, the color of the guide line 109 may be such that the guide line 109 is stands out over the trailer coupler 107. For example, the guide line 109 may be displayed on the display device 215 as a wide black dotted line, while the trailer coupling is displayed as a light color so that the driver may still be able to visualize the trailer coupler while using the guide line for guidance.

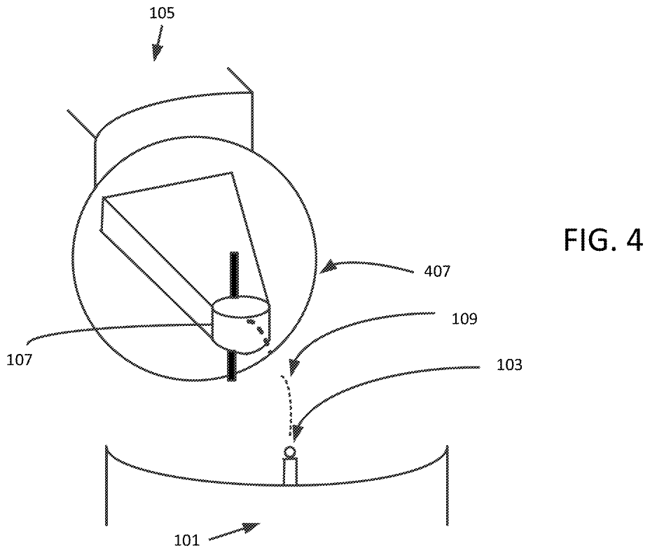

Alternatively, as the vehicle 101 approaches the trailer coupler 107, the view of an area centered on an end of the guide line near the trailer coupler 107 may be enlarged (via a zoom function of the display device) in the display device 215. For example, FIG. 4 illustrates a display of an enlarged view of an area containing the trailer coupler. Although FIG. 4 shows an enlarged view as a circle, other shapes are possible, such as square, rectangular, or oval. The enlarged view 407 may assist the driver in verifying the location of the trailer coupler 107 and assist the driver in visualizing changes in the turning angle as the vehicle is backed at an angle toward the trailer coupler 107. In some embodiments, the viewing area corresponding to the enlarged view is moved as the steering angle is changed.

Alternatively, in one embodiment, when the distance between the trailer coupler 107 and the hitch ball 103 is shortened to within a predetermined distance, the processing circuitry 211 may enhance (enlarge/zoom) the entire screen or may adjust the length and line shape (e.g., dotted, line width) of displaying the guide line 109 so as to display the trailer coupler 107 and guide line 109 for easy viewing. Also, in some embodiments, an enlarged view of an area containing the trailer coupler may be moved along with adjustment of the display of the guide line, where both the movement and adjustment are performed in accordance with changes in the steering angle.

In one embodiment, the trailer coupler 107 may be detected by performing image recognition using the vision processing circuitry 211. Once the trailer coupling 107 is recognized in a captured video image, the guide line 109 may be displayed on the display device 215 as a path to the trailer coupler 107. In one embodiment, the trailer coupler 107 may be detected by allowing the user to indicate a location on a touch screen of the display device 215. A touchscreen of the display device 215 showing the coupler 107 may be touched by a user. Upon detecting a touch of the image at a position of the coupler, the guide line 109 may be displayed as a path to the trailer coupler 107.

Although the examples thus far have described a single display device 217, other embodiments may include more than one display device 215, each showing different views of the rear of the vehicle, or each showing the same view of the rear of the vehicle on different displays located throughout or in the vicinity of the vehicle. In some embodiments, a display device may be located remotely from the vehicle, for example, to monitor the progress of the vehicle.

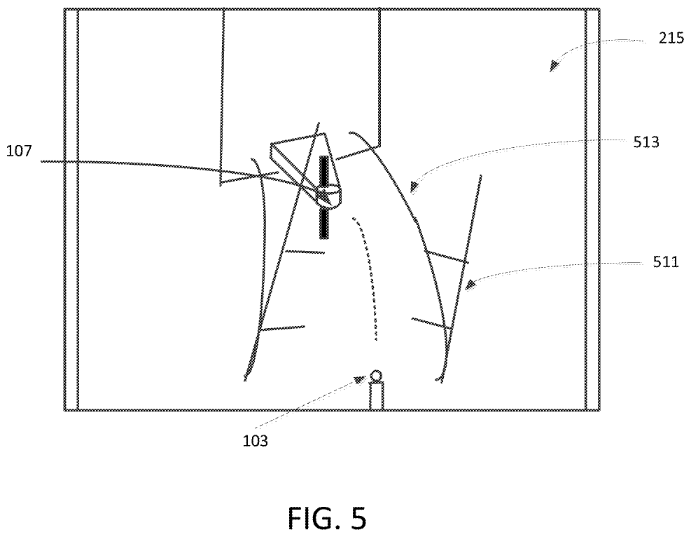

FIG. 5 illustrates a detailed display for a display device of the backup camera system of FIG. 2. In addition to displaying an image of the trailer and trailer coupling 107, the backup camera system may display vehicle boundary lines 511 that mark a range of rear boundaries at different distances from the rear of the vehicle. The backup camera system may display in the display device 215 steering lines 513 which may be generated based on the steering angle of the vehicle. The steering angle of the vehicle may be determined by the processing circuitry 211 based on the angle of the wheels as controlled by the steering wheel. Alternatively, the steering angle may be determined by the processing circuitry 211 based on the position of the steering wheel. The angle of the wheels and the position of the steering wheels may be obtained by specific sensors. However, because the view from the rear camera 213 is two-dimensional, it is difficult for the vision processing circuitry 211 to determine the position of the coupler 107. In particular, distances are difficult to determine based on the video image alone. For example, the vision processing circuitry will have difficulty in detecting the distance to the trailer coupler 107. The position of the trailer couple 107 may only be approximated, and the distance between the hitch ball 103 and the trailer coupler 107 cannot be accurately determined.

One approach to determine the position of the trailer coupler 107 in three-dimensions is to take into consideration the height of the coupler from the ground. In other words, in order to accurately determine the position of the trailer coupler 107, the height of the coupler 107 may be used by the processing circuitry 211 in determining other distances relative to the height of the coupler. In one embodiment, to obtain the height of the coupler a user may enter height information of the coupler into the display device 215. The height information of the coupler may also be obtained based on previously stored height information stored in memory 313. In one embodiment, the height information may be obtained based on average height information of trailer couplers previously stored in memory 313.

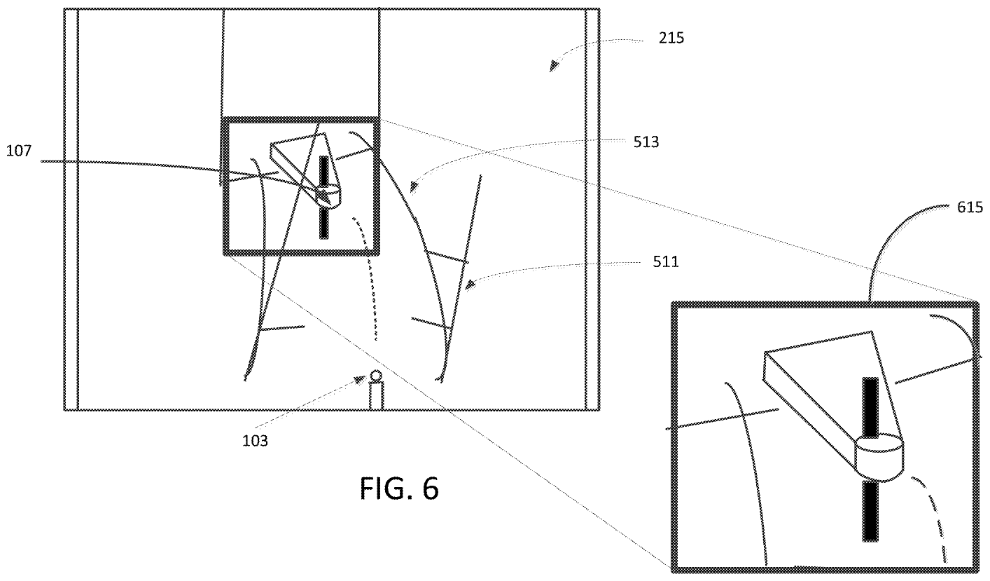

Further, the position of the trailer coupler 107 may be determined by narrowing the detection target viewing range of the coupler according to the steering angle of the vehicle. For example, regarding FIG. 6 the current position of the trailer coupler 107 can be narrowed down to displayed view 615, in the vicinity of the center of the target viewing range determined based on the steering angle. In some embodiments, the viewing range in the displayed view 615 may be moved as the steering angle is changed.

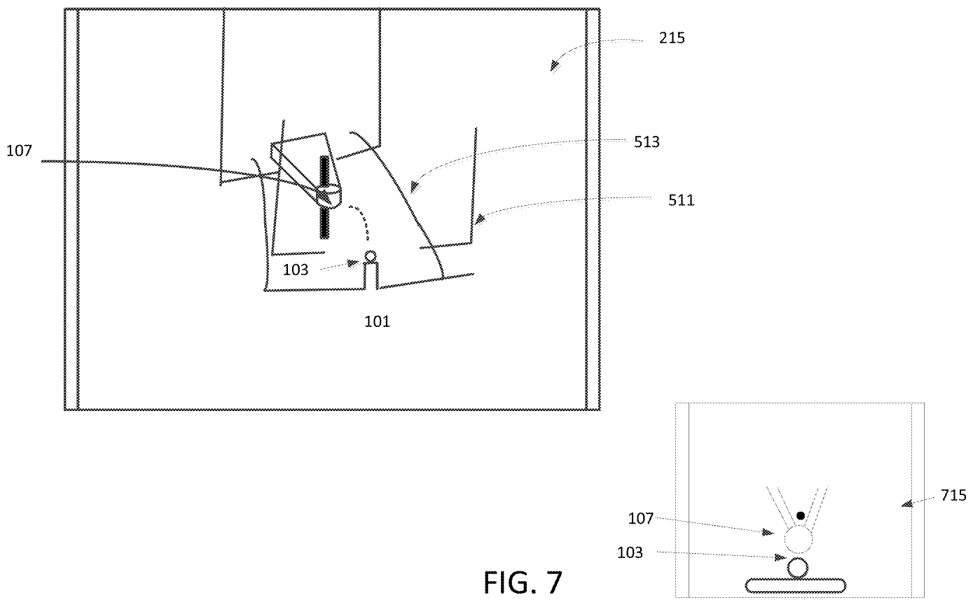

As the vehicle approaches a trailer 105 to within a predetermined distance, in one embodiment, in order to accurately position the hitch ball 103 with the trailer coupler 107, a view from above the hitch ball may be displayed to assist the driver in precisely positioning the hitch ball 103 with the trailer coupler 107. FIG. 7 illustrates a display for the backup camera system where the video camera 213 captures an image 715 from above the hitch ball 103. As mentioned above, in order to capture a view from above the hitch ball towards the ground, the video camera 213 may include a wide angle lens that captures a video signal that is wide in the vertical direction.

Numerous modifications and variations of the present invention are possible in light of the above teachings. It is therefore to be understood that within the scope of the appended claims, the invention may be practiced otherwise than as specifically described herein.

1. A backup camera system for a vehicle having a trailer hitch, the system comprises:
at least one camera mounted to a rear of the vehicle;
a display device, and
processing circuitry configured to
capture a video image from the at least one camera,
generate a guide line in accordance with a steering angle of the vehicle,
superimpose the guide line on the video image for guiding a direction from the trailer hitch towards a coupler of a trailer,
display the captured video image with the superimposed guide line, and
enlarge a view of an area centered on an end of the guideline that is adjacent to the coupler.

2. The backup camera system of claim 1, wherein the processing circuitry moves the area in the enlarged view based on changes of the steering angle of the vehicle.

3. The backup camera system of claim 2, wherein the processing circuitry detects a two-dimensional position of the coupler as captured in the video image, and
obtains a third dimension of the position of the coupler.

4. The backup camera system of claim 3, wherein the processing circuitry obtains height information of the coupler as the third dimension of the position of the coupler.

5. The backup camera system of claim 3, wherein the processing circuitry obtains average height information from previously stored height information of various couplers as the third dimension of the position of the coupler.

6. The backup camera system of claim 3, wherein the processing circuitry enhances the display such that when the guide line approaches the coupler, the color of the guide line shows through.

7. The backup camera system of claim 3, wherein the processing circuitry enhances the display such that when the guide line approaches the coupler, the processing circuitry superimposes the enlarged view on the video image.

8. The backup camera system of claim 3, wherein the processing circuitry detects a two-dimensional position of the coupler by performing image recognition on the video image captured by the camera.

9. The backup camera system of claim 3, wherein the processing circuitry detects a two-dimensional position of the coupler detection information based on whether or not the display of the captured video image is touched by a user.

10. The backup camera system of claim 3, wherein the processing circuitry detects a two-dimensional position of the coupler detection information by narrowing the detection range of the coupler according to the steering angle of the vehicle.

11. The backup camera system of claim 3, wherein as the vehicle approaches the trailer to stop position, the processing circuitry enhances the display by adjusting the view angle of the camera so that the captured video image is a view from substantially above the trailer hitch.

12. A method for a backup camera system for a vehicle having a trailer hitch, the method comprises:
capturing a video image of a coupler of a trailer from at least one camera;
generating, by processing circuitry, a guide line in accordance with a steering angle of the vehicle;
superimposing, by the processing circuitry, the guide line on the video image for guiding a direction from the trailer hitch towards a coupler of a trailer;
displaying the captured video image with the superimposed guide line; and
enlarging, by the processing circuitry, a view of an area centered on an end of the guideline that is adjacent to the coupler.

13. The method of claim 12, further comprising moving, by the processing circuitry, the area in the enlarged view based on changes of the steering angle of the vehicle.

14. The method of claim 13, further comprising detecting, by the processing circuitry, a two-dimensional position of the coupler as captured in the video image, and
obtaining a third dimension of the position of the coupler.

15. The method of claim 14, wherein the obtaining includes obtaining height information of the coupler as the third dimension of the position of the coupler.

16. The method of claim 14, wherein the obtaining includes obtaining average height information from previously stored height information of various couplers as the third dimension of the position of the coupler.

17. The method of claim 14, wherein the enhancing includes enhancing the display such that when the guide line approaches the coupler, the color of the guide line shows through.

18. The method of claim 14, wherein the enhancing includes enhancing the display such that when the guide line approaches the coupler, the processing circuitry superimposes the enlarged view on the video image.

19. The method of claim 14, wherein the detecting includes detecting a two-dimensional position of the coupler by performing image recognition on the video image captured by the camera.

20. The method of claim 14, wherein the detecting includes detecting a two-dimensional position of the coupler detection information based on whether or not the display of the captured video image is touched by a user.
